(19) United States
(12) Patent Application Publication
(10) Pub. No.: US 2025/0033208 A1
(43) Pub. Date: Jan. 30, 2025

(54) TEACHING OPERATION PANEL AND ROBOT CONTROL SYSTEM

(71) Applicant: FANUC CORPORATION, Yamanashi (JP)

(72) Inventor: Kengo SHIMIZU, Yamanashi (JP)

(21) Appl. No.: 18/836,756

(22) PCT Filed: Feb. 28, 2022
(86) PCT No.: PCT/JP2022/008362

§ 371 Date: Aug. 8, 2024

(51) Int. Cl. B25J 9/16; B25J 13/00; B25J 13/06; G06F 3/0488; G10L 15/22

(52) U.S. Cl. CPC B25J 9/1656; B25J 13/003; B25J 13/06; G10L 15/22; G06F 3/0488; G10L 2015/223

(57) ABSTRACT

This teaching operation panel sends out a command to a robot control device for controlling the actions of a robot. The teaching operation panel comprises a voice input unit by which a user inputs voice commands, and a voice recognition unit for recognizing a voice command acquired by the voice input unit. The teaching operation panel also comprises a processing unit that, on the basis of the result of voice recognition by the voice recognition unit, transmits at least one command from among operations in an action program of the robot and termination of alarms to the robot control device.

### FIELD

The present invention relates to a teach pendant and a robot control system.

### BACKGROUND

In a robot system of conventional technology, in order to ensure safety of a worker, safety measures are taken so that the worker does not enter a work area of a robot during the period in which the robot is driven. For example, a safety fence is installed around the robot, and it is prohibited for workers to enter the inside of the safety fence during the period in which the robot is driven. In recent years, a robot system has been known in which a worker works in cooperation with a robot. In this robot system, the robot and the worker can carry out the work at the same time in the state where the safety fence is not provided around the robot (see, for example, Japanese Unexamined Patent Publication (Kokai) No. 2018-30185A).

When the worker works in cooperation with the robot, the robot can be operated on a teach pendant. On the teach pendant, a button, a dial, and the like are arranged in addition to a display unit for displaying information. The worker operates the button, the dial, and the like on the teach pendant so as to send a command for the operation of the robot to a robot controller. Further, in the conventional technology, in regard to a device including a display unit for displaying an image, it is known to operate an image displayed on the display unit by voice (see, for example, Japanese Unexamined Patent Publication (Kokai) No. 2006-68865A and Japanese Unexamined Patent Publication (Kokai) No. H01-240293A).

### CITATION LIST

### Patent Literature

[PTL 1] Japanese Unexamined Patent Publication (Kokai) No. 2018-30185A
[PTL 2] Japanese Unexamined Patent Publication (Kokai) No. 2006-68865A
[PTL 3] Japanese Unexamined Patent Publication (Kokai) No. H01-240293A

### SUMMARY

### Technical Problem

The worker needs to operate the button, the dial, and the like of the teach pendant when operating the robot on the teach pendant. For this reason, there is a problem that the work being performed by the worker must be interrupted when the worker operates the robot. Further, in a working environment where the worker's hands are dirty, preparations such as washing the hands, wiping the hands, or removing gloves are required before operating the teach pendant. In other words, other work is required in order to operate the teach pendant. Therefore, regarding the conventional teach pendant, there is a problem that the work efficiency of the worker is poor.

### Solution to Problem

A teach pendant according to an aspect of the present disclosure sends a command to a robot controller that controls motion of a robot. The teach pendant includes a voice input unit to which a worker inputs a voice command, and a voice recognition unit configured to recognize a voice command acquired by the voice input unit. The teach pendant includes a processing unit configured to transmit, to the robot controller, at least one of a command for an operation of a motion program of the robot and a command for a reset of an alarm, based on a result of recognition of a voice command by the voice recognition unit.

A robot control system according to the present disclosure includes the teach pendant described above, and a robot controller that controls motion of a robot.

### Advantageous Effects of Invention

An aspect of the present disclosure can provide a teach pendant that improves work efficiency of a worker, and a robot control system including the teach pendant.

### BRIEF DESCRIPTION OF DRAWINGS

FIG. 1 is a schematic diagram of a robot system according to an embodiment.

FIG. 2 is a block diagram of a robot system including a first teach pendant according to the embodiment.

FIG. 3 is an image displayed on a display unit of the teach pendant.

FIG. 4 is an image for selecting a language in which voice recognition is performed.

FIG. 5 is an explanatory diagram of an image of an icon for performing a mute function for stopping voice recognition.

FIG. 6 is an image in which a warning is displayed on the display unit of the teach pendant.

FIG. 7 is an explanatory diagram illustrating terms for the operation by voice by a worker.

FIG. 8 is a flowchart of control for sending a command to a robot controller by a voice input.

FIG. 9 is an image for confirming an operation displayed before a motion program is executed.

FIG. 10 is a block diagram of a second teach pendant according to the embodiment.

FIG. 11 is an explanatory diagram illustrating a voice output from the second teach pendant.

### DESCRIPTION OF EMBODIMENTS

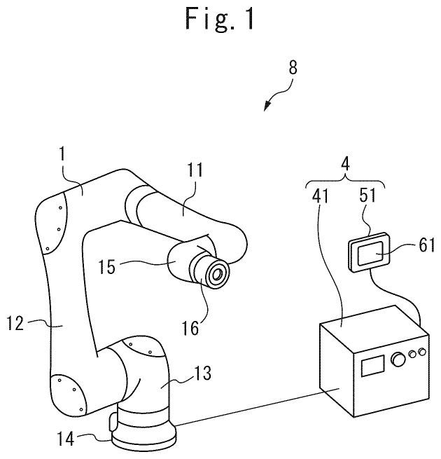

A teach pendant and a robot control system including the teach pendant according to an embodiment will be described with reference to FIGS. 1 to 11. A robot system according to the present embodiment includes a work tool, a robot, and the robot control system. The robot control system includes the teach pendant and a robot controller that controls the robot. In the robot system according to the present embodiment, a worker and the robot perform predetermined work in cooperation with each other.

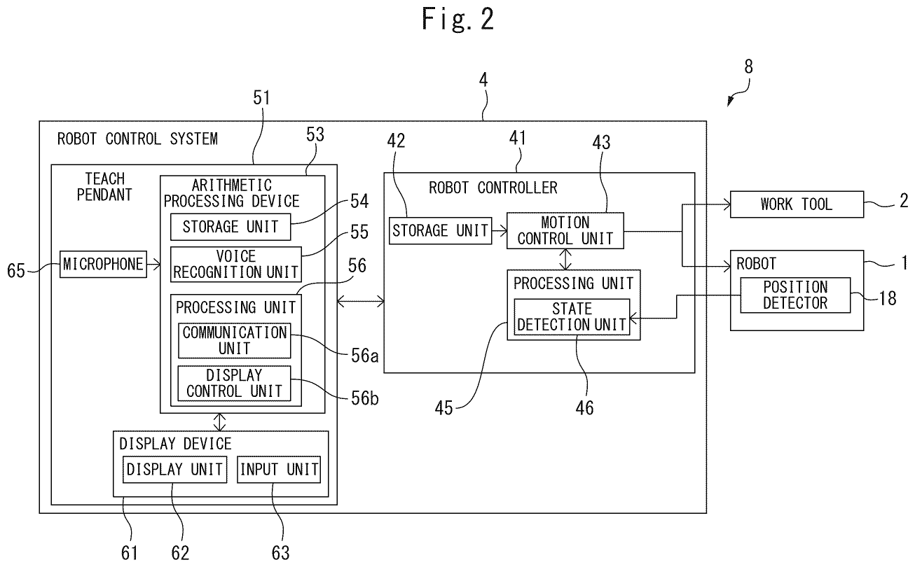

FIG. 1 illustrates a perspective view of the robot system according to the present embodiment. FIG. 2 illustrates a block diagram of the robot system according to the present embodiment. With reference to FIGS. 1 and 2, a robot system 8 according to the present embodiment performs work based on a motion program. The robot system 8 includes a work tool 2 as an end effector, and a robot 1 that moves the work tool 2. Any type of work tool 2 can be attached to the robot 1 according to the type of work performed by the robot system 8. For example, when the robot system 8 carries a workpiece, a hand can be attached to the robot 1. Alternatively, when the robot system 8 performs arc welding, a welding torch may be attached to the robot 1.

The robot 1 according to the present embodiment is a vertically articulated robot including a plurality of joint portions. The robot 1 includes a turning base 13 supported by a base portion 14. The turning base 13 is formed to rotate with respect to the base portion 14. The robot 1 includes an upper arm 11 and a lower arm 12 which are rotatably supported via the respective joint portions. Further, the upper arm 11 rotates about a rotation axis parallel to a direction in which the upper arm 11 extends.

The robot 1 includes a wrist 15 rotatably coupled to an end portion of the upper arm 11. The wrist 15 includes a flange 16 being rotatably formed. The work tool 2 is fixed to the flange 16 of the wrist 15. The robot 1 according to the present embodiment includes six joint axes, but the robot is not limited to such a configuration. Any type of robot that can move a work tool can be adopted.

The robot 1 according to the present embodiment is a cooperative robot for performing work together with a worker. The cooperative robot includes a sensor for detecting an external force applied to the robot. For example, the cooperative robot includes a force sensor disposed on a base portion, or includes a torque sensor disposed on each joint axis, and is thus formed to be able to detect an external force applied to the robot. When the robot 1 is in contact with a worker or another object and detects an external force, a robot controller 41 limits motion of the robot 1. For example, in this case, the robot controller 41 stops the robot, or reduces a driving speed of the robot.

Alternatively, in the cooperative robot, a component such as an arm or a base is covered with a housing having a soft surface so as to allow the cooperative robot to come into contact with a worker or the like. It should be noted that the robot is not limited to such a cooperative robot, and may be a robot that performs work alone without cooperating with a worker.

The robot 1 includes a robot driving device for changing a position and a posture of the robot 1. The robot driving device includes an electric motor that drives a component such as an arm, a wrist, and the like. The work tool 2 includes a tool driving device for driving the work tool 2. The tool driving device includes an electric motor for driving the work tool 2, and the like. A position detector 18 that outputs a rotational position of the joint axis of the robot 1 is disposed in the robot 1. The position detector 18 is, for example, formed of an encoder attached to an electric motor. The robot controller 41 can detect a position and a posture of the robot 1 from an output of the position detector 18.

The robot system 8 includes a robot control system 4. The robot control system 4 includes the robot controller 41 including an arithmetic processing device including a central processing unit (CPU) as a processor. The robot controller 41 constitutes a controller main body. The arithmetic processing device includes a random access memory (RAM), a read only memory (ROM), and the like connected to the CPU via a bus.

The arithmetic processing device of the robot controller 41 includes a storage unit 42 that stores predetermined information. The storage unit 42 stores information about control of the robot 1 and the work tool 2. The storage unit 42 may be formed of a non-transitory storage medium that can store information. For example, the storage unit 42 may be formed of a storage medium such as a volatile memory, a non-volatile memory, a magnetic storage medium, or an optical storage medium. A motion program of the robot in which motion of the robot is defined is stored in the storage unit 42.

The arithmetic processing device of the robot controller 41 includes a motion control unit 43 that sends a motion command of the robot. The motion control unit 43 corresponds to a processor which operates according to the motion program. The motion control unit 43 is formed to be able to read information stored in the storage unit 42. The motion control unit 43 sends a motion command for driving the robot 1 to an electric circuit of the robot driving device, based on the motion program. The motion control unit 43 sends a motion command for driving the work tool 2 to an electric circuit of the tool driving device, based on the motion program. The robot 1 and the work tool 2 are driven based on the motion program.

The arithmetic processing device of the robot controller 41 includes a processing unit 45 that executes information processing and arithmetic operations. The processing unit 45 includes a state detection unit 46 that detects a state of the robot 1 and the work tool 2. The state detection unit 46 detects a position and a posture of the robot 1 and a position and a posture of the work tool 2, based on an output of the position detector 18. Each of the processing unit 45 and the state detection unit 46 corresponds to a processor operating according to a program generated in advance. The processor reads the program and performs control defined in the program, and thus functions as each unit.

The robot control system 4 includes a first teach pendant 51 with which a worker operates the robot 1, inputs information needed for control of the robot system 8, and confirms information needed for control of the robot system 8. The teach pendant 51 functions as an operation device for operating the robot 1. The teach pendant 51 is connected to the robot controller 41 via a communication device. The teach pendant 51 sends a command to the robot controller 41 that controls motion of the robot 1 and the work tool 2.

The teach pendant 51 in the present embodiment is formed of a tablet computer. The teach pendant 51 includes a display device 61 including a display panel that displays an image. The display panel of the display device 61 functions as a display unit 62 that displays various types of information. The display device 61 according to the present embodiment is formed to be able to detect an input operation by a worker touching a screen of the display device 61. The display device 61 according to the present embodiment includes a display panel of a touch panel type. As the display panel of the touch panel type, a display panel of any type such as a resistive film type, a capacitance type, a surface acoustic wave type, or the like can be adopted.

A worker can perform an input operation by operating an image displayed on the display panel with his/her finger. The display device 61 is formed to display an image (icon) of a button for operating the robot 1 and the work tool 2. Alternatively, the display device 61 may be formed to display an image for inputting or selecting predetermined information.

The display device 61 is formed to be able to detect a pressed position on the screen when the worker presses the screen with his/her finger. The display device 61 is formed to determine that an image of an icon displayed on the screen is pressed when the worker presses the image of the icon with his/her finger. For example, by pressing an icon displayed on the screen of the display panel with a finger, the worker can perform an operation of the robot corresponding to the icon. In this way, the display panel according to the present embodiment functions as an input unit 63 that detects an input operation by a worker.

It should be noted that the teach pendant is not limited to a tablet computer. The teach pendant may include a display unit that displays information about control of the robot system, and an input unit including an input device such as a button, a keyboard, and a dial. The display unit may be formed of any type of display panel such as a liquid crystal display panel without having the function of a touch panel.

The teach pendant according to the present embodiment is formed of a portable terminal. The teach pendant is configured to communicate with the robot controller in a wired or wireless manner. The portable terminal is not limited to a tablet computer, and any type of portable terminal can be adopted as the teach pendant. For example, the portable terminal may be a smartphone, and the like.

The teach pendant 51 includes an arithmetic processing device 53 including a CPU as a processor. The arithmetic processing device 53 includes a storage unit 54 that stores various types of information about the robot system. The storage unit 54 may be formed of a non-transitory storage medium that can store information. For example, the storage unit 54 may be formed of a storage medium such as a volatile memory, a non-volatile memory, a magnetic storage medium, or an optical storage medium.

The teach pendant 51 in the present embodiment is formed to be able to send, to the robot controller 41, a command for controlling motion of the robot 1 and the work tool 2, based on a voice of a worker. The teach pendant 51 includes a microphone 65 as a voice input unit with which a worker inputs a voice. The microphone 65 in the present embodiment is built in a main body of the teach pendant 51. The microphone 65 may be disposed away from the main body of the teach pendant 51. For example, a headset including a microphone may be adopted as the voice input unit. In this case, the microphone can communicate with the arithmetic processing device 53 by wireless communication. Further, any type of device that can acquire a voice of a worker may be adopted as the voice input unit.

The arithmetic processing device 53 includes a voice recognition unit 55 that recognizes a voice acquired by the microphone 65. The voice recognition unit 55 can recognize a voice of a worker by various types of voice recognition methods. For example, the voice recognition unit 55 can convert a voice of a term uttered by a worker into characters. For example, after the voice recognition unit 55 performs data conversion on a voice by an acoustic analysis, the voice recognition unit 55 can estimate characters represented by the voice by using an acoustic model. Then, based on the estimated characters, the voice recognition unit 55 can estimate a word by using a dictionary stored in advance, or generate a sentence by using a language model.

The arithmetic processing device 53 includes a processing unit 56 that processes a result of recognition of a voice by the voice recognition unit 55. The processing unit 56 includes a communication unit 56a that transmits and receives data to and from the robot controller 41. The communication unit 56a sends, to the robot controller 41, at least one of a command for an operation of a motion program of the robot 1 and a command for a reset of an alarm. The processing unit 56 receives an input operation performed by a worker via the input unit 63 of the display device 61. The processing unit 56 includes a display control unit 56b that controls an image displayed on the display unit 62 of the display device 61. The display control unit 56b controls an image based on a result of recognition of a voice by the voice recognition unit 55. Alternatively, the display control unit 56b controls an image based on an input operation performed by a worker via the input unit 63.

Each of the voice recognition unit 55, the processing unit 56, the communication unit 56a, and the display control unit 56b included in the arithmetic processing device 53 described above corresponds to the processor which operates according to a program generated in advance. The processor reads the program and performs control defined in the program, and thus functions as each unit.

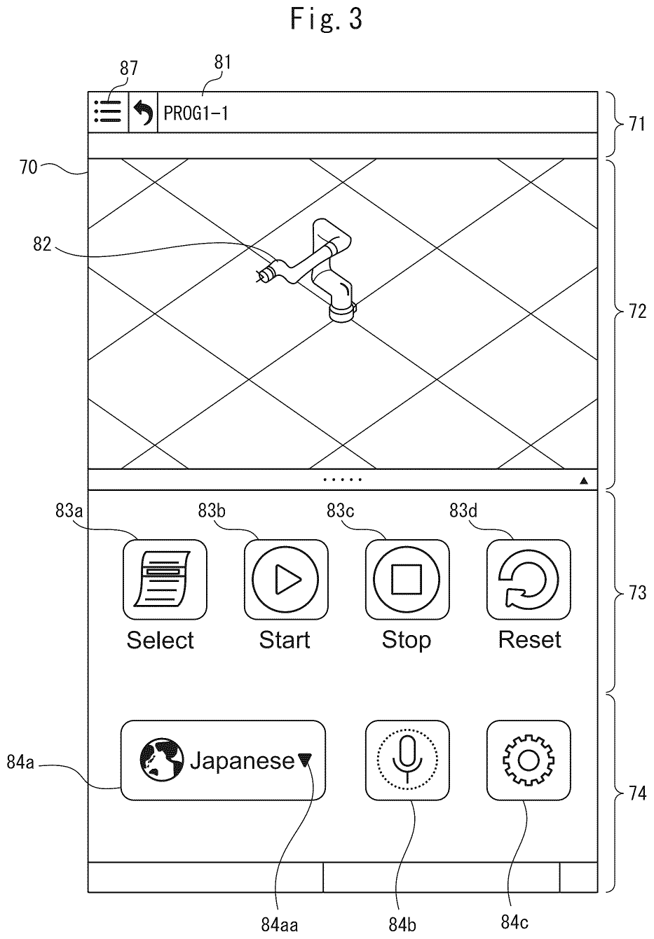

FIG. 3 illustrates an image displayed on the screen of the display unit in the present embodiment. An image 70 is displayed when the robot system 8 performs work. The image 70 includes an information display region 71 in which predetermined information is displayed. In the information display region 71, for example, an image 81 of a name of a motion program, an icon 87 displaying an image of a menu of various functions, or the like is displayed.

The image 70 includes a robot display region 72 in which an image of the robot 1 is displayed. In the robot display region 72 according to the present embodiment, a three-dimensional image 82 of the robot 1 is displayed in such a way as to correspond to a current posture of the robot 1. Information for generating the three-dimensional image 82 of the robot is stored in advance in the storage unit 54 of the teach pendant 51. For example, a three-dimensional model of each component of the robot such as an arm is stored in the storage unit 54. Such a three-dimensional model can be created in advance by the processing unit 45 of the robot controller 41, based on three-dimensional shape data about the robot, and the like.

The state detection unit 46 of the robot controller 41 acquires a rotational angle of the electric motor in the joint axis from the position detector 18, and calculates a position and a posture of the robot 1. The communication unit 56a of the teach pendant 51 acquires a position and a posture of the robot from the robot controller 41. The display control unit 56b generates the image 82 of the robot by using angles of the joints of the joint portions and the three-dimensional models of the components of the robot.

In this way, the display device displays a three-dimensional image of the robot such that the image corresponds to a current posture of the robot, and thus a worker can confirm the current posture of the robot on the teach pendant. Further, the worker can confirm a three-dimensional position of the robot. For example, when the worker performs work in a position where the robot is hard to see, the worker can confirm a position and a posture of the robot by viewing the image displayed on the display device.

The display control unit 56b according to the present embodiment can display the image 82 of the robot such that the robot 1 is viewed from a viewpoint designated by a worker. The worker can designate a viewpoint for displaying the image 82 of the robot by an operation of touching the robot display region 72. For example, the worker can rotate the image 82 of the robot with respect to the base portion of the robot as the rotation center by moving his/her finger while pressing the robot display region 72 with the finger. In other words, the display control unit 56b changes a viewpoint by rotating the image 82 of the robot according to a drag operation on the robot display region 72. By this control, the worker can confirm a position and a posture of the robot by viewing an image in which the robot is viewed along a desired direction.

Further, the display control unit 56b according to the present embodiment can display the image 82 of the robot according to the magnification factor designated by a worker. The worker can enlarge the image 82 of the robot by widening the interval between two fingers touching the robot display region 72. Alternatively, the worker can reduce the image 82 of the robot by narrowing the interval between the two fingers. In this way, the display control unit 56b can enlarge the image 82 of the robot by detecting the pinch-out, and can reduce the image 82 of the robot by detecting the pinch-in.

Further, the display control unit 56b may display a trajectory of motion of the robot. The storage unit 54 can store positions and postures of the robot 1 at predetermined time intervals while the position and the posture of the robot 1 change. The display control unit 56b may display a motion path of the robot based on a position and a posture of the robot at each time. As a trajectory of motion of the robot, for example, a trajectory on which the rotation center of the surface of the flange 16 of the robot 1 moves can be adopted. Alternatively, when an image of the work tool is displayed, a trajectory of a tool tip point can be adopted as a trajectory of motion of the robot.

The image 70 displayed on the display unit 62 includes an operation region 73 in which at least one of an icon for an operation of a motion program of the robot and an icon for a reset of an alarm is displayed. The robot controller 41 controls the robot 1 and the work tool 2 based on a command from the teaching operation device 51. Further, the display control unit 56b of the teach pendant 51 displays processing results on the display unit 62. In the present embodiment, four icons 83a to 83d to be operated by a worker are displayed in the operation region 73.

The icon 83a is an icon for selecting one motion program among a plurality of prepared motion programs. The icon 83b is an icon for starting the selected motion program and driving the robot 1 and the work tool 2. The icon 83c is an icon for stopping the motion program and stopping the robot 1 and the work tool 2. The icon 83d is an icon for resetting an alarm of the robot system 8. For example, when the robot controller 41 detects an abnormality in motion of the robot 1 or the work tool 2, the robot controller 41 may issue an alarm. The icon 83d is an icon for resetting such an alarm.

The operation of the motion program of the robot according to the present embodiment includes selection, activation, and a stop of the motion program of the robot. However, the operation of the motion program of the robot is not limited to these examples. For example, the operation of the motion program may include deletion of the motion program, addition of the motion program, correction of the motion program, or the like.

The image 70 displayed on the display unit 62 includes a voice recognition setting region 74 for performing setting of voice recognition. An icon 84a is an icon displaying an image for selecting a language in which voice recognition is performed. An icon 84b is an icon for executing the mute function of temporarily stopping voice recognition. An icon 84c is an icon for performing setting of voice recognition other than the setting described above.

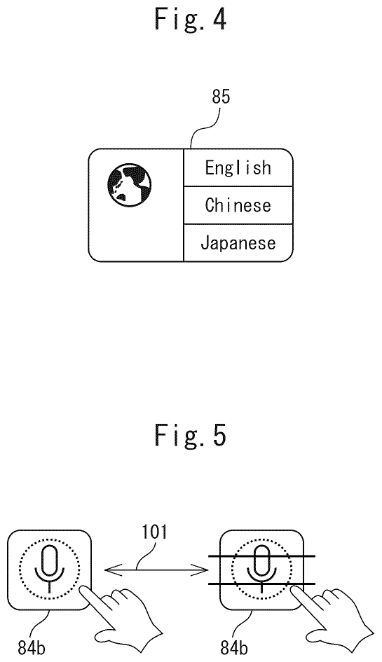

FIG. 4 illustrates an image for selecting a language of voice recognition. With reference to FIGS. 3 and 4, a worker selects a language for performing voice recognition by operating the icon 84a in the voice recognition setting region 74. When the worker presses a button 84aa arranged in the icon 84a, the display control unit 56b displays an image 85 for selecting a language. In an example of the image 85 herein, a language is selected from English, Chinese, and Japanese. The worker can select a language to be used in voice recognition by pressing a desired language on the image 85. In the icon 84a, the selected language is displayed. Herein, Japanese is selected. It should be noted that terms displayed on the screen may also be switched to terms in the selected language.

FIG. 5 is an explanatory diagram illustrating an operation of an icon for stopping voice recognition. With reference to FIGS. 3 and 5, the icon 84b for stopping the function of performing an operation by voice recognition is arranged in the voice recognition setting region 74. In the present embodiment, the function of performing an operation by voice recognition is maintained unless a worker makes a setting to stop the operation by voice recognition. In other words, a state where an operation of the teach pendant is performed according to a predetermined command statement uttered by the worker is maintained unless the worker makes a setting to stop the operation by voice recognition.

The worker can stop the operation by voice recognition as indicated by an arrow 101 by pressing the icon 84b. In this case, an image such as a strikeout is added to the icon 84b in order to indicate that the function of voice recognition is stopped. The operation by voice recognition can be restarted by pressing the icon 84b once again. Normally, the worker does not press the icon 84b for the mute function and therefore the state where the operation by voice recognition is activated is maintained.

With reference to FIG. 3, the worker can perform setting of voice recognition other than the setting described above by pressing the icon 84c arranged in the voice recognition setting region 74 with his/her finger. For example, setting of sensitivity of the microphone, and the like can be performed.

Next, control for operating the robot 1 and the work tool 2 will be described. In the present embodiment, an operation of a motion program of the robot and a reset of an alarm can be performed by both of a touch operation of touching the screen of the display device 61 and an operation by voice.

First, an example of controlling motion of the robot 1 by performing the operation of touching the screen of the display device 61 with a finger will be described with reference to FIGS. 2 and 3. In response to the operation of touching an icon by a worker, the processing unit 56 of the teach pendant 51 transmits a command corresponding to the touched icon to the robot controller 41. The worker can perform a desired operation in a way of pressing one of the icons in the operation region 73. In the image 70 according to the present embodiment, icons for operating the robot system 8 to perform the routine work of the robot system 8 are put together in one operation region 73. With this configuration, operability regarding the operation of the robot by the worker is improved.

In response to pressing of the icon 83a by the worker, an image in which a plurality of motion programs are included is displayed. The display control unit 56b can display an image in which names of the plurality of programs are described, similarly to the image displaying the plurality of languages illustrated in FIG. 4. The worker selects one motion program by pressing one motion program among the plurality of motion programs. The image 81 of the name of the selected motion program is displayed in the information display region 71.

Next, the worker can start the selected motion program by pressing the icon 83b. The communication unit 56a of the processing unit 56 transmits the name of the selected motion program and a command for starting the motion program to the motion control unit 43 of the robot controller 41. The motion control unit 43 starts driving of the robot 1 and the work tool 2 based on the selected motion program.

Next, when the worker presses the icon 83c in the image 70, the communication unit 56a sends a command for stopping the motion program to the motion control unit 43 of the robot controller 41. In this case, the motion control unit 43 stops the motion program being currently executed. The motion control unit 43 stops the work tool 2 and the robot 1. In this way, a motion program for performing work can be operated by pressing the icons 83a to 83c. Selection, activation, and a stop of the motion program can be performed.

Further, the robot controller 41 can detect that an operating state of the robot system 8 is abnormal while the robot 1 and the work tool 2 are driven. The processing unit 45 of the robot controller 41 can detect an abnormality in an operating state of the robot, based on an output of the position detector 18, a sensor for detecting an external force attached to the robot 1, or the like.

For example, when a person comes into contact with the robot 1 and thereby the external force increases, the processing unit 45 can determine that the operating state of the robot is abnormal. In this case, the processing unit 45 can send a command for stopping the robot 1 or a command for reducing the motion speed of the robot 1 to the motion control unit 43. Alternatively, the processing unit 45 can send a motion command of the robot 1 so that the robot 1 performs motion to avoid contact with an object.

The processing unit 45 sends, to the teach pendant 51, information indicating that an abnormal state has occurred and a driving state of the robot has been changed. The communication unit 56a of the processing unit 56 of the teach pendant 51 receives the information indicating that the abnormality has occurred.

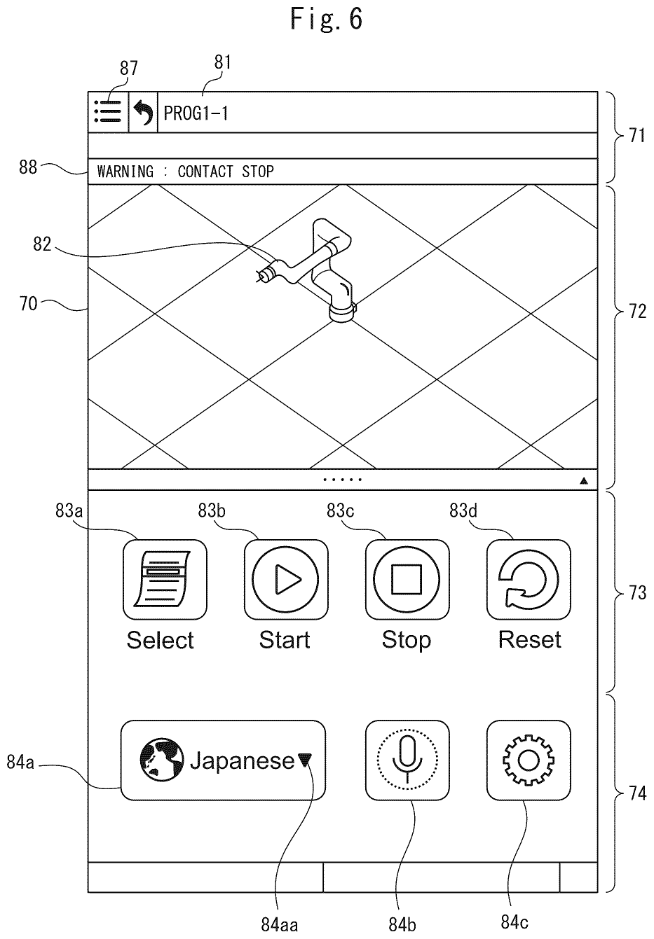

FIG. 6 illustrates an example of an image displayed on the display device when an abnormality occurs in a motion state of the robot system. The display control unit 56b of the processing unit 56 of the teach pendant 51 displays, in the information display region 71, an image 88 of a warning indicating that an object or a person has come into contact with the robot system and the robot system has been stopped. In the example herein, the robot 1 is stopped, and the warning is also displayed on the display unit 62. A worker can reset an alarm by pressing the icon 83d in the operation region 73. The worker can reset the alarm after confirming that the abnormality is resolved. In the example herein, the worker presses the icon 83d, and thus the image 88 of the warning displayed in the information display region 71 is deleted. Then, the worker can restart the work of the robot system by pressing the icon 83b for starting the motion program.

Next, on the teach pendant 51 in the present embodiment, the worker can execute, by an operation by voice, the same functions as those executed by the operation of pressing the icons 83a to 83d arranged in the operation region 73. In other words, a command can be executed by voice instead of pressing one of the icons 83a to 83d.

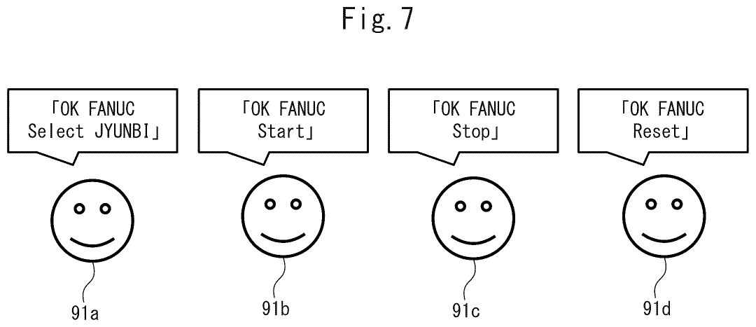

FIG. 7 is an explanatory diagram illustrating an operation by voice for comparison with the operation of pressing an icon in the operation region. In the present embodiment, a worker, after saying a predetermined term (fixed phrase), utters a term of each command. In the present embodiment, “OK FANUC” is adopted as the predetermined term. After saying “OK FANUC”, the worker utters a command for an operation and a term related to the command for the operation. When the voice recognition unit 55 acquires a voice of “OK FANUC”, the voice recognition unit 55 determines that a command designated by the worker starts.

By adding a predetermined term (such as “OK FANUC”) for starting a command before a term of a command of the robot system, the voice recognition unit 55 can avoid false voice recognition of the term of the command. For example, the voice recognition unit 55 is prevented from erroneously recognizing a term as a command in a situation where a plurality of workers are speaking. The term for starting a command is not limited to the above example, and any term can be adopted. For example, the term for starting a command may include a name (CRX) of the robot such as “ROBOT CRX”.

A worker 91a can perform, by uttering a term related to a motion program after “OK FANUC Select”, the same operation as the operation of selecting a motion program by pressing the icon 83a in the operation region 73. When a worker selects a desired program from a plurality of motion programs, the worker utters a file name of the motion program as a command by voice. For example, “PROG1-1” can be adopted as a name of a program. In this case, the worker utters “OK FANUC Select PROG1-1”, so that the voice recognition unit 55 can recognize the selected motion program as a motion program having a file name of “PROG1-1”.

However, a name of a motion program is often formed of an English letter, a number, a symbol, and the like. There is a problem that an English letter, a number, and a symbol are difficult to recognize by voice. As a result, the recognition rate of voice recognition may decrease, and a motion program may not be able to be selected or a false motion program may be selected.

For this reason, according to the present embodiment, a motion program is provided with attribute information for voice recognition in addition to a file name. In the present embodiment, an annotation of a motion program is provided as attribute information. Any annotation different from a name of a motion program may be included in an attribute file attached to a file of the motion program. Alternatively, a name of a program corresponding to an annotation may be stored in a storage unit. The annotation may be another name of the program or a term related to the program. Herein, a term “JYUNBI” is stored as an annotation in an attribute file of a motion program for carrying a workpiece. Since Japanese is selected herein, “JYUNBI” representing preparation of a workpiece in Japanese is set in the attribute file.

With reference to FIG. 7, herein, setting is performed in such a way that an annotation is used for voice recognition when a motion program is selected. The worker 91a utters “OK FANUC Select JYUNBI” instead of pressing the icon 83a for selecting a motion program. The voice recognition unit 55 recognizes that the annotation is “JYUNBI”. The voice recognition unit 55 recognizes that the input command by voice is a command for selecting a motion program having the annotation of “JYUNBI”. The processing unit 56 selects a name of the motion program provided with the annotation of “JYUNBI”. The communication unit 56a of the processing unit 56 transmits the selected name of the motion program to the robot controller 41.

In this way, in the operation of selecting a motion program, a motion program can be selected by a predetermined annotation different from a name of the motion program. The processing unit transmits a command for the operation of the motion program corresponding to the annotation to the robot controller. By performing this control, false voice recognition can be suppressed, and the accuracy of selection of a motion program by voice is improved.

Next, a worker 91b can start the selected motion program by uttering “OK FANUC Start” instead of pressing the icon 83b for starting a motion program arranged in the operation region 73. Further, a worker 91c can stop the currently executed motion program by uttering “OK FANUC Stop” instead of pressing the icon 83c for stopping a motion program. The voice recognition unit 55 recognizes that the input command by voice is a command for a start or a stop of the motion program. The communication unit 56a transmits the command for starting or stopping the motion program to the robot controller 41.

Further, when an alarm is issued in the robot system, a worker 91d can reset the alarm by uttering “OK FANUC Reset” as in the case where the worker 91d presses the icon 83d. The voice recognition unit 55 recognizes the input command by voice is a command for resetting the alarm. The communication unit 56a transmits the command for resetting the alarm to the robot controller 41.

In this way, in the present embodiment, an operation can be performed by voice instead of operating an icon displayed on the display unit. In the present embodiment, a command by voice corresponding to a command by the operation of an icon displayed on the display unit can be executed. In the present embodiment, a worker can instruct the robot system to perform, by voice recognition, at least one of a command for an operation of the robot and a command for a reset of an alarm. Thus, the worker can reduce the number of times the teach pendant is operated during a period in which the robot system performs work. The worker does not need to discontinue his/her own work, and therefore the work efficiency of the worker improves. Further, work for washing hands or removing gloves in order to operate the teach pendant can be avoided, and therefore the work efficiency of the worker improves.

In particular, the robot according to the present embodiment is a cooperative robot. Therefore, the robot system and a worker perform the same work or perform different pieces of work at the same time. In this case, the worker can change motion programs, start a motion program, stop a motion program, and reset an alarm without viewing and operating the teach pendant. Thus, the work efficiency of the worker can be improved, and the time required for the cooperative work with the robot can be reduced.

As actual work performed by a worker and the robot system in cooperation with each other, assembly of parts can be exemplified. For example, the robot carries a workpiece into a predetermined workplace. The robot maintains the position and the posture of the workpiece. The worker attaches a first part to the workpiece carried by the robot. Next, the robot changes the orientation of the workpiece and then maintains the position and the posture of the workpiece in the workplace. The worker attaches, to the workpiece, a second part different from the first part. After attachment of the parts is completed, the robot carries the workpiece to a predetermined position.

As a motion program, a first motion program including a motion command for carrying in a workpiece and disposing the workpiece at a predetermined workplace and a motion command for changing an orientation of the workpiece can be generated in advance. Further, a second motion program including a motion command for carrying out the workpiece from the workplace to a predetermined position can be generated in advance.

When the work is performed, the worker selects the first motion program by a command by voice of “Select”, and starts driving of the robot by a command by voice of “Start”. When the workpiece is carried into the workplace, the robot is stopped by a command by voice of “Stop”. Herein, the worker attaches the first part to the workpiece. When attachment of the first part is completed, the worker restarts motion by the first motion program by the command by voice of “Start”. The robot 1 changes an orientation of the workpiece based on the first motion program. The worker stops driving of the robot by the command by voice of “Stop”. Then, the worker attaches the second part to the workpiece.

After attachment of the second part is completed, the worker selects the second motion program by the command by voice of “Select”. Then, the robot is driven by the command by voice of “Start”, and the workpiece is carried. When the workpiece is carried to the predetermined position being determined in advance, the worker stops the robot by the command by voice of “Stop”.

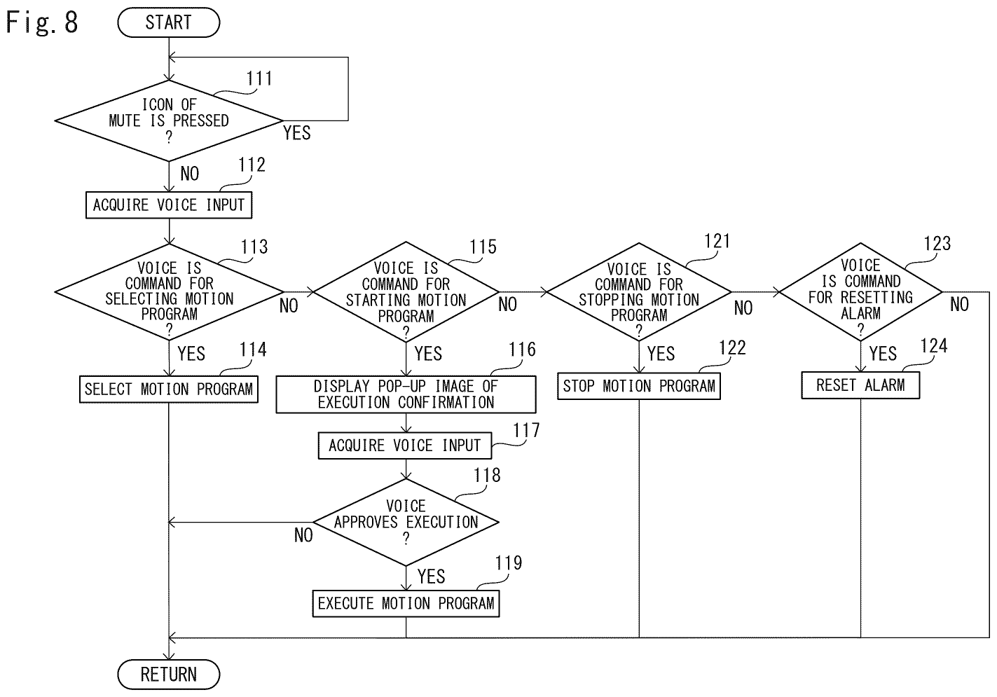

In this way, the worker can, by voice, select a motion program, execute a motion program, and stop a motion program even when the work is complicated. The worker can perform the operation of the motion program quickly. Thus, the work efficiency of cooperative work improves. FIG. 8 illustrates a flowchart of control performed by the arithmetic processing device of the teach pendant according to the present embodiment. FIG. 8 is a flowchart of control for performing an operation by voice recognition. With reference to FIGS. 2, 3, and 8, in step 111, the processing unit 56 determines whether the icon 84b in the voice recognition setting region 74 is pressed. In other words, the processing unit 56 determines whether the icon 84b for activating the mute function is pressed. In step 111, when the icon 84b is pressed and the mute function is selected, the control is repeated. In step 111, when the icon 84b is not pressed, the control shifts to step 112.

In step 112, the voice recognition unit 55 acquires a voice command from the microphone 65. The voice recognition unit 55 recognizes the voice command. For example, the voice recognition unit 55 converts the voice command into characters. Next, in step 113, the voice recognition unit 55 determines whether the acquired voice command is a command for selecting a motion program. In the present embodiment, whether the acquired voice command is a voice command starting with “OK FANUC Select” is determined. In step 113, when the acquired voice command is the command for selecting the motion program, the control shifts to step 114. Then, in step 114, the voice recognition unit 55 determines the motion program designated by the voice command. The processing unit 56 transmits a name of the selected motion program to the motion control unit 43 of the robot controller 41.

Further, the display control unit 56b displays the name of the selected motion program in an image displayed on the display device 61. In the image 70, the image 81 of the name of the program is displayed in the information display region 71. The display control unit 56b may display the annotation of the motion program.

In step 113, when the voice command is not the command for selecting the motion program, the control shifts to step 115. In step 115, the voice recognition unit 55 determines whether the voice command is a command for starting the motion program. In other words, whether the voice command is “OK FANUC Start” is determined. In step 115, when the voice command is the command for starting the motion program, the control shifts to step 116.

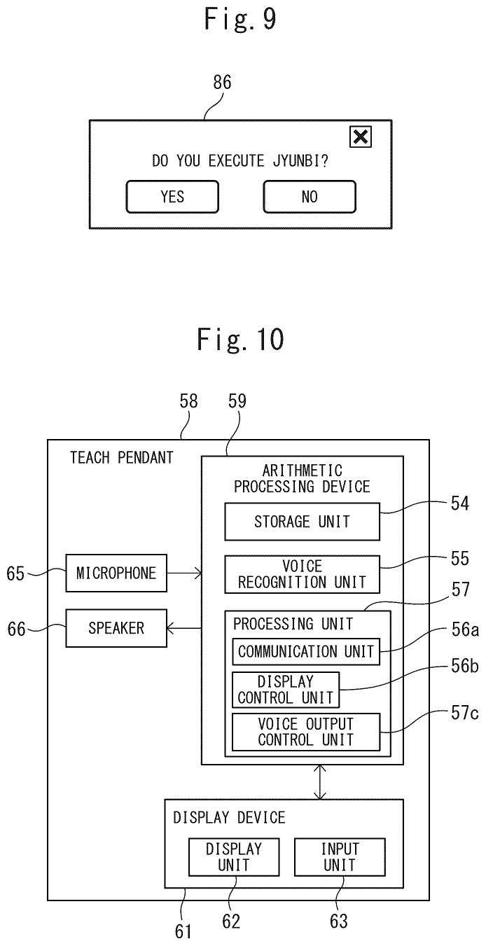

FIG. 9 illustrates an image for confirmation displayed when the command for starting the motion program is acquired. With reference to FIGS. 8 and 9, in step 116, the display control unit 56b displays a pop-up image 86 for confirming execution of the motion program. Herein, the pop-up image 86 including a message that asks a question about whether to execute the motion program having the annotation of “JYUNBI” is displayed.

In step 117, the voice recognition unit 55 acquires a voice command. In step 118, the voice recognition unit 55 determines whether execution of the motion program is approved. Herein, when the voice recognition unit 55 acquires a voice command of “OK FANUC NO”, the voice recognition unit 55 determines that execution of the motion program is not approved. Then, the control ends.

When the voice recognition unit 55 acquires a voice command of “OK FANUC YES”, the voice recognition unit 55 determines that execution of the motion program is approved. In this case, the control shifts to step 119.

In step 119, the selected motion program is executed. The processing unit 56 of the teach pendant 51 sends a command for starting the selected motion program to the motion control unit 43 of the robot controller 41. The motion control unit 43 starts execution of the selected motion program.

It should be noted that the image 86 including a message that asks a question about execution of the motion program is displayed in the present embodiment, but the present invention is not limited to such an embodiment. The motion program may be immediately executed without displaying the image 86 including a message that asks a question about execution of the motion program.

With reference to FIG. 8, in step 115, when the voice command is not the command for starting the motion program, the control shifts to step 121. In step 121, the voice recognition unit 55 determines whether the voice command is a command for stopping the motion program. The voice recognition unit 55 determines whether the voice command acquired from the microphone 65 is “OK FANUC Stop”. In step 121, when the voice command is the command for stopping the motion program, the control shifts to step 122.

In step 122, the motion of the robot system is stopped. The processing unit 56 of the teach pendant 51 sends the command for stopping the motion program to the motion control unit 43 of the robot controller 41. The motion control unit 43 stops the motion of the robot 1 and the work tool 2.

In step 121, when the voice command is not the command for stopping the motion program, the control shifts to step 123. In step 123, the voice recognition unit 55 determines whether the voice command is a command for resetting an alarm. In other words, whether the voice command of the worker is “OK FANUC Reset” is determined. When the voice command of the worker is not the command for resetting the alarm, the control ends. When the voice command of the worker is the command for resetting the alarm, the control shifts to step 124.

In step 124, the processing unit 56 of the teach pendant 51 sends the command for resetting the alarm to the motion control unit 43 of the robot controller 41. Further, the display control unit 56b performs control for deleting the alarm from the image of the display device 61. For example, the display control unit 56b performs control for deleting the image 88 of the warning in FIG. 6.

The control illustrated in FIG. 8 can be repeatedly performed at predetermined time intervals. Then, in accordance with a voice input by the worker via the microphone, at least one of an operation of the robot and a reset of an alarm can be performed.

In this way, a worker can perform, by voice commands, the operations of the robot system being often performed on a daily basis. In particular, in the teach pendant according to the present embodiment, the operation of the robot system by icons in the operation region and the operation of the robot system by the voice recognition are limited to the frequently used operations of a motion program of the robot and a reset of an alarm. Thus, cooperative work with the robot system can be efficiently performed by a simple operation on the screen or a simple command sentence by voice.

In the present embodiment, control for deactivating the voice recognition is performed by an operation of pressing an icon for muting, but the present invention is not limited to such an embodiment. An icon for enabling or disabling the voice recognition may be displayed.

FIG. 10 illustrates a block diagram of a second teach pendant provided in the robot control system in the present embodiment. A second teach pendant 58 includes a speaker 66 as a voice output unit that outputs predetermined information by voice. The second teach pendant 58 is formed of a tablet terminal including an arithmetic processing device 59 including a CPU as a processor, similarly to the first teach pendant 51. In the present embodiment, the speaker 66 is built in the tablet terminal. In another embodiment, the speaker 66 may be disposed in a position away from a portable terminal. The speaker 66 may be disposed in a workspace so that a worker can hear a voice output from the speaker 66. For example, the speaker may be fixed to a stand or the like and may be formed to communicate with the arithmetic processing device.

A processing unit 57 of the arithmetic processing device 59 includes a voice output control unit 57c that controls a voice output from the speaker 66, in addition to the communication unit 56a and the display control unit 56b. The processing unit 57 and the voice output control unit 57c correspond to a processor which operates according to a predetermined program. By operating according to the program, the processor functions as the processing unit 57 and the voice output control unit 57c. The second teach pendant 58 can change an image displayed on the display device 61 by the display control unit 56b, and also output a voice command from the speaker 66.

The voice output control unit 57c of the processing unit 57 outputs, from the speaker 66, a voice command input by a worker by voice. For example, when a worker operates the robot by voice, the voice output control unit 57c can output a voice command expressing completion of the operation of the robot. Alternatively, when a worker inputs a voice command for an operation of the robot system, the voice output control unit 57c can ask, by voice, a question about whether to really perform an operation of the robot.

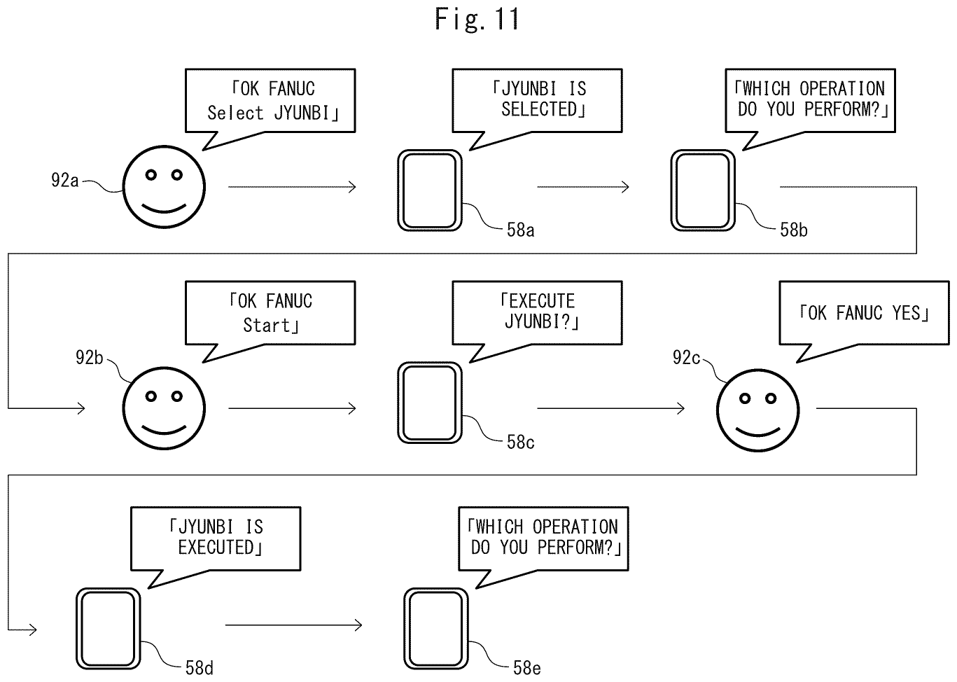

FIG. 11 is an explanatory diagram illustrating a voice output from the speaker by the voice output control unit. By way of example, control for interaction between one worker and one teach pendant will be described herein. A worker 92a utters “OK FANUC Select JYUNBI”, and thus the voice recognition unit 55 recognizes that the command input by voice is a command for selecting a motion program having the annotation of “JYUNBI”. The processing unit 56 transmits, to the robot controller 41, information indicating that the motion program having the annotation of “JYUMBI” is selected. The voice output control unit 57c of a teach pendant 58a outputs a voice command “JYUNBI is selected” from the speaker 66.

Next, the voice output control unit 57c of a teach pendant 58b outputs, from the speaker 66, a voice asking a question about which operation is to be performed. In response to the question, a worker 92b utters a command for starting the motion program.

Next, the display control unit 56b of a teach pendant 58c displays the image 86 (see FIG. 9) for confirming execution of the motion program. Then, the voice output control unit 57c of the teach pendant 58c outputs by voice a confirmation of execution of the motion program from the speaker 66. In response to the voice output, a worker 92c utters a command approving execution of the motion program. The voice recognition unit 55 recognizes that the command input by voice is approval of execution of the motion program. The motion control unit 43 of the robot controller 41 executes the motion program according to the command from the processing unit 57 of the teach pendant.

Next, the voice output control unit 57c of a teach pendant 58d outputs, from the speaker 66, a voice saying that the motion program is executed. Then, the voice output control unit 57c of a teach pendant 58e outputs, from the speaker 66, a voice asking a question about which operation is to be performed. A worker may utter a command in response to the question at a desired timing. By thus outputting a voice from the teach pendant, the worker can continue the work while confirming whether a command for an operation input by voice by the worker is correctly recognized by the voice recognition. Further, the robot system can perform work without a mistake. Further, the voice output control unit may output a voice asking a question to a worker. By this control, the worker can continue the operation of the robot system in such a way as to interact with the teach pendant.

The other configuration, action, and advantageous effects of the second teach pendant 58 are similar to those of the first teach pendant 51, and thus the descriptions thereof will not be repeated.

In the teach pendant according to the present embodiment, an operation by a touch on the screen of the display device can be performed in addition to an operation by voice recognition. Thus, when the voice recognition cannot be accurately performed or when a false operation is selected by the voice recognition, a worker can perform an operation of the robot system by touching the screen.

In each of the control procedures described above, the order of steps can be appropriately changed within a range in which the functions and the technical effects thereof are not changed.

The embodiments described above can be appropriately combined. In each of the drawings described above, the same or similar portion has the same reference sign. It should be noted that the embodiments described above are exemplifications, and do not limit the invention. Further, the embodiments include a change in the embodiments indicated in the claims.

### REFERENCE SIGNS LIST

1 Robot
4 Robot control system
8 Robot system
41 Robot controller
43 Motion control unit
51, 58 Teach pendant
58a to 58e Teach pendant
54 Storage unit
55 Voice recognition unit
56, 57 Processing unit
56b Display control unit
57c Voice output control unit
61 Display device
65 Microphone
66 Speaker
70, 82 Image
83a to 83d Icon

1. A teach pendant configured to send a command to a robot controller that controls motion of a robot, the teach pendant comprising:
a voice input unit to which a worker inputs a voice command;
a voice recognition unit configured to recognize a voice command acquired by the voice input unit; and
a processing unit configured to transmit, to the robot controller, at least one of a command for an operation of a motion program of the robot and a command for a reset of an alarm, based on a result of recognition of a voice command by the voice recognition unit.

2. The teach pendant according to claim 1, further comprising a display device configured to be able to detect an input operation of touching a screen by a worker, wherein
the display device is configured to display at least one of an icon for an operation of a motion program of a robot and an icon for a reset of an alarm, and
based on an operation of touching an icon by a worker, the processing unit transmits a command corresponding to the icon to the robot controller.

3. The teach pendant according to claim 1, further comprising a voice output unit configured to output predetermined information by voice,
wherein the processing unit outputs, from the voice output unit, a voice related to the voice command of the worker.

4. The teach pendant according to claim 1, wherein an operation of a motion program of a robot includes selection, activation, and a stop of a motion program of a robot.

5. The teach pendant according to claim 1, wherein
with respect to a motion program, an annotation different from a name of the motion program is set as attribute information, and,
when the voice recognition unit recognizes that a voice of a worker matches the annotation, the processing unit transmits, to the robot controller, a command for an operation of the motion program corresponding to the annotation.

6. The teach pendant according to claim 1, wherein the robot is a cooperative robot for performing work together with the worker.

7. The teach pendant according to claim 1, further comprising a display device configured to display an image,
wherein the display device displays a three-dimensional image of the robot such that the three-dimensional image of the robot corresponds to a current posture of the robot.

8. A robot control system comprising:
the teach pendant according to claim 1; and
a robot controller configured to control motion of a robot based on a command from the teach pendant.
